(19) United States
(12) Patent Application Publication
(10) Pub. No.: US 2015/0188148 A1
(43) Pub. Date: Jul. 2, 2015

(54) FUEL CELL COMPONENT

(71) Applicant: SOLVAY SPECIALTY POLYMERS USA, LLC., Alpharetta, GA (US)

(72) Inventors: Gregory J. Warkoski, Cumming, GA (US); Brian Baleno, Alpharetta, GA (US); Linda M. Norfolk, Cumming, GA (US)

(73) Assignee: SOLVAY SPECIALTY POLYMERS USA, LLC., Alpharetta, GA (US)

(21) Appl. No.: 14/423,454

(22) PCT Filed: Aug. 29, 2013
(86) PCT No.: PCT/EP2013/067877

§ 371 Date: Feb. 24, 2015

Related U.S. Application Data
(60) Provisional application No. 61/694,820, filed on Aug. 30, 2012.

(51) Int. Cl. H01M 8/02

(52) U.S. Cl. CPC H01M 8/02

(57) ABSTRACT

A fuel cell component, preferably an endplate, comprising a polymer composition (C) comprising: at least one polyamide polymer [polyamide (A)] comprising recurring units derived from the polycondensation of at least one phthalic acid and hexamethylenediamine and less than 10% moles of recurring units derived from the polycondensation of adipic acid and hexamethylene diamine, at least one reinforcing filler [filler (F)] and at least one impact modifier [impact modifier (IM)]. The fuel cell component may be manufactured by conventional molding techniques.

This application claims priority to U.S. provisional application No. 61/694820 filed on 30 Aug. 2012, the whole content of this application being incorporated herein by reference for all purposes.

### TECHNICAL FIELD

The present invention relates to the field of fuel cells, in particular to fuel cell components, e.g. endplates, made of thermoplastic materials.

### BACKGROUND ART

A fuel cell is an electrochemical energy conversion device that produces electricity and heat by the reaction of a fuel, e.g., hydrogen, and an oxidant, e.g. air. Numerous variations exist on the design and configuration of fuel cell system, however, an integral part of most systems is a fuel cell stack. A fuel cell stack is comprised of a series of membrane electrode assemblies separated from one another by bipolar collector plates wherein the stack terminates at both ends with an endplate assembly comprising an endplate and, typically, a compression plate. The stack is also provided with fuel and oxidant gas supply and removal means, as well as a means of circulating coolant through the stack. Connecting means, for example, tie rods or bands, hold the stack together and, in conjunction with the endplate assemblies, exert a compressive force on the stack tightening the stack assembly. Such a tightening is required to decrease the contact resistance among the components of the membrane electrode assemblies and the bipolar collector plates and to secure the gas sealing properties of the stack.

To avoid stack failure and maximize electric efficiency, the endplate assemblies must be strong enough to withstand the force exerted on the stack without breaking or warping. Typically, the endplate assembly also needs to withstand use temperatures of up to 70° C. or higher. Additionally, when the endplate functions as the manifold through which coolant, fuel, and oxidant gas are introduced and removed from the stack, the endplate may need to withstand contact with such materials without deteriorating or corroding.

In view of the mechanical and thermal resistance requirements, the compression plates and endplates contained in the endplate assemblies are typically fabricated from metal, usually stainless steel. In addition to being relatively high in cost and susceptible to corrosion, metal plates can add substantially to the weight of a fuel cell stack in view of the thickness required to provide an adequate mechanical resistance. In automotive and other applications it is generally desirable to minimize the size and weight of the fuel cell stack.

Similar issues as those described for the endplates apply in general also to the other structural components of a fuel cell, for instance the pump housings, humidifier housings, coolant, fuel and oxidant inlets and outlets, coolant, fuel and oxidant manifolds, stack supports and the like.

The use of plastic materials in the fabrication of lighter weight endplates has been suggested. US 2002182470 A (TICONA LLC) 05.12.2002 discloses molded fuel cell endplates made from a long fiber reinforced thermoplastic resin composite comprising a thermoplastic resin and at least 30 wt % of a long strand glass fiber having a fiber length of at least 5 mm. The thermoplastic resin may be selected from the group consisting of partially aromatic polyamides, polyarylsulfones, polyaryletherketones, polyaryletheretherketones, polyaryletherimides, polyarylimides, polyarylene sulfide and thermotropic liquid crystals. Examples are provided of long fiber reinforced polyphenylene sulfide endplates.

US 20030152819 (MATSUSHITA ELECTRIC INDUSTRIAL CO., LTD) 14.08.2003 discloses endplates made by a resin-dominant material slected from polypropylene, nylon resin, polyacetal, polycarbonate, modified polyphenylether, polybutylene terephthalate, ultrahigh molecular weight polyethylene, polymethylpentente, syndiotactic polystyrene, polysulfone, polyethersulfone, polyphthalamide, polyphenylene sulfide, polycyclohexylene dimethylene terephthalate, polyarylate, polyetherimide, polyether ether ketone, polyimide, fluorocarbon resin, silicone resin and liquid crystal polymer. Examples are provided of endplates made of glass fiber reinforced polyphenylene sulfide, glass fiber reinforced polysulfone and glass fiber reinforced liquid crystal polymer.

WO 2005/031904 A (R. JEREZ) 07.04.2005 discloses a plate member for a fuel cell comprising a polymeric or crystalline thermoplastic material selected from at least one of polyphthalamide, polyphenylene sulfide, polyether ether ketone and a liquid crystal polymer.

### DISCLOSURE OF THE INVENTION

It has now been found that fuel cell components, in particular endplates, provided with an advantageous balance between ductility and mechanical resistance needed for thick structural parts, amount of extractables in harsh environments and cost can be obtained by the use of a polymer composition (C) comprising at least one polyamide polymer [polyamide (A)] comprising recurring units derived from the polycondensation of at least one phthalic acid and hexamethylenediamine and less than 10% moles of recurring units derived from the polycondensation of adipic acid and hexamethylenediamine, at least one reinforcing filler [filler (F)] and at least one impact modifier [impact modifier (IM)].

Thus a first object of the present invention is a fuel cell component comprising a polymer composition (C) comprising at least one polyamide polymer [polyamide (A)] comprising recurring units derived from the polycondensation of at least one phthalic acid and hexamethylenediamine and less than 10% moles of recurring units derived from the polycondensation of adipic acid and hexamethylenediamine, at least one reinforcing filler [filler (F)] and at least one impact modifier [impact modifier (IM)].

Non-limiting examples of fuel cell components are for instance endplates, pump housings, humidifier housings, coolant, fuel and oxidant inlets and outlets, coolant, fuel and oxidant manifolds, stack supports.

In a preferred embodiment of the invention the fuel cell component is a fuel cell endplate.

Recurring units derived from the polycondensation of adipic acid and hexamethylenediamine are preferably less than 5% moles in polyamide (A), more preferably less than 3% moles and even more preferably 0% moles.

For the purpose of the present invention, the term “polyamide polymer” refers to any polymer which comprises recurring units which are derived from the polycondensation of at least one dicarboxylic acid component, or derivative thereof, and at least one diamine component and/or from the polycondensation of aminocarboxylic acids and/or lactams. The expression “derivative thereof” when used in combination with the expression ‘carboxylic acid’ is intended to denote whichever derivative which is susceptible of reacting in polycondensation conditions to yield an amide bond. Examples of amide-forming derivatives include a mono- or di-alkyl ester, such as a mono- or di-methyl, ethyl or propyl ester, of such carboxylic acid; a mono- or di-aryl ester thereof; a mono- or di-acid halide thereof; and a mono-or di-acid amide thereof, a mono- or di-carboxylate salt.

The dicarboxylic acid component and the diamine component are generally comprised in substantially equimolecular amount in the polyamide (A); this means that the molar ratio between the overall number of —COOH groups of the dicarboxylic acid component and the overall number of —NH₂ groups of the diamine component is of 1.1:1 to 0.9:1, preferably of 1.075:1 to 1:0.925.

Polyamide (A) comprises recurring units deriving from the polycondensation reaction of at least one phthalic acid and hexamethylenediamine.

The expression “phthalic acid” is used to refer to anyone of isophthalic acid, terephthalic acid and orthophthalic acid.

According to an embodiment of the present invention, the at least one phthalic acid is selected from the group consisting of isophthalic acid, and terephthalic acid. Isophthalic acid and terephthalic acid can be used alone or in combination. The phthalic acid is preferably terephthalic acid in combination with isophthalic acid.

In addition to the at least one phthalic acid polyamide (A) may comprise up to 40% moles, preferably up to 30% moles, more preferably up to 25% moles based on all the dicarboxylic acid component of polyamide (A) of a dicarboxylic acid component different from phthalic acid with the proviso that recurring units deriving from adipic acid and hexamethylenediamine are less than 10% moles. Said dicarboxylic acid component different from phthalic acid may be selected from the group consisting of aromatic dicarboxylic acids and non-aromatic dicarboxylic acids.

For the purpose of the present invention, a dicarboxylic acid is considered as “aromatic” when it comprises one or more than one aromatic group.

Non limiting examples of suitable aromatic dicarboxylic acids are 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, the 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid, 1,2-naphthalene dicarboxylic acid.

Non limiting examples of suitable non-aromatic dicarboxylic acids for use in polyamide (A) are oxalic acid [HOOC—COOH], malonic acid (HOOC—CH₂—COOH), adipic acid [HOOC—(CH₂)₄—COOH], succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], 2,4,4-trimethyl-adipic acid [HOOC—CH(CH₃)—CH₂—C(CH₃)₂—CH₂—COOH], pimelic acid [HOOC—(CH₂) ₅—COOH], suberic acid [HOOC—(CH₂)₆—COOH], azelaic acid [HOOC—(CH₂) ₇—COOH], sebacic acid [HOOC—(CH₂)₈—COOH], undecanedioic acid [HOOC—(CH₂)₉—COOH], dodecandioic acid [HOOC—(CH₂)₁₀—COOH], tetradecandioic acid [HOOC—(CH₂)₁₁—COOH], cis- and/or trans-cyclohexane-1,4-dicarboxylic acid and/or cis- and/or trans-cyclohexane-1,3-dicarboxylic acid.

When said dicarboxylic acid component different from phthalic acid is selected from the group consisting of non-aromatic dicarboxylic acids, and in particular adipic acid, it is preferably present in an amount of less than 10% moles based on all the dicarboxylic acid component; more preferably said non-aromatic dicarboxylic acids component is present in an amount of less than 5% moles and even more preferably in an amount of less than 3% moles.

In addition to hexamethylenediamine polyamide (A) may comprise up to 40% moles, preferably up to 30% moles, more preferably up to 25% moles based on all the diamine component of polyamide (A) of a diamine component different from hexamethylenediamine.

Said diamine component different from hexamethylenediamine is typically selected from the group consisting of aliphatic alkylene diamines having 2 to 18 carbon atoms. Said amine is advantageously selected from the group consisting of 1,2-diaminoethane, 1,2-diaminopropane, propylene-1,3-diamine, 1,3-diaminobutane, 1,4-diaminobutane, 1,5-diaminopentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1.8-diamino-1,3-dimethyloctane, 1,8-diamino-1,4-dimethyloctane, 1,8-diamino-2,4-dimethyloctane, 1,8-diamino-3,4-dimethyloctane, 1,8-diamino-4,5-dimethyloctane, 1,8-diamino-2,2-dimethyloctane, 1,8-diamino-3,3-dimethyloctane, 1,8-diamino-4,4-dimethyloctane, 1,6-diamino-2,4-diethylhexane, 1,9-diamino-5-methylnonane, 1,11-diaminoundecane and 1,12-diaminododecane.

Preferably, said diamine component different from hexamethylenediamine is selected from the group consisting of aliphatic alkylene diamines having 5 to 12 carbon atoms.

Non limiting examples of polyamides (A) according to the present invention are: the copolymer of terephthalic acid and isophthalic acid with hexamethylenediamine, the copolymer of terephthalic acid with hexamethylenediamine and decamethylenediamine; the copolymer of terephthalic acid and isophthalic acid with hexamethylenediamine and decamethylenediamine; the copolymer of terephthalic acid with hexamethylenediamine and 11-amino-undecanoic acid; the copolymer of terephthalic acid with hexamethylenediamine and bis-1,4-aminomethylcyclohexane; the copolymer of terephthalic acid with hexamethylenediamine and bis-1,3-aminomethylcyclohexane; the copolymer of hexamethylenediamine with terephthalic acid and 2,6-napthalenedicarboxylic acid; the copolymer of hexamethylenediamine with terephthalic acid and sebacic acid; the copolymer of hexamethylenediamine with terephthalic acid and 1,12-diaminododecanoic acid; the copolymer of hexamethylenediamine with terephthalic acid, isophthalic acid and adipic acid; the copolymer of hexamethylenediamine with terephthalic acid, isophthalic acid and 1,4-cyclohexanedicarboxylic acid; the copolymer of terephthalic acid with hexamethylenediamine and 2-methylpentamethylenediamine.

Polyamide (A) is preferably selected from the group consisting of the copolymers of terephthalic acid and isophthalic acid with hexamethylenediamine, the copolymers of terephthalic acid and isophthalic acid with hexamethylenediamine and decamethylenediamine, the copolymers of hexamethylenediamine with terephthalic acid and sebacic acid.

Polyamide (A) is more preferably selected from the group consisting of the copolymers of terephthalic acid and isophthalic acid with hexamethylenediamine.

Even more preferably polyamide (A) selected from the group consisting of the copolymers of terephthalic acid and isophthalic acid with hexamethylenediamine wherein the molar ratio terephthalic acid/isophthalic acid ranges from 60/40 to 75/25.

Suitable polyamides (A) are notably available as AMODEL® PPAs from Solvay Specialty Polymers US, L.L.C.

The weight percent of polyamide (A) in composition (C) is generally of at least 40 wt %, preferably of at least 45 wt %, more preferably of at least 50 wt %, based on the total weight of composition (C). The weight percent of polyamide (A) is generally of at most 85 wt %, preferably of at most 75 wt % and most preferably of at most 70 wt %, based on the total weight of composition (C).

Composition (C) further comprises at least one reinforcing filler [filler (F)]. Reinforcing fillers which are suitable to be used in the composition (C) of the invention are well known by the skilled in the art.

Filler (F) is generally selected from the group consisting of fibrous fillers and particulate fillers. Typically, filler (F) is selected from the group consisting of mineral fillers (such as talc, mica, kaolin, calcium carbonate, calcium silicate, magnesium carbonate), glass fiber, carbon fibers, synthetic polymeric fiber, aramid fiber, aluminum fiber, titanium fiber, magnesium fiber, boron carbide fibers, rock wool fiber, steel fiber, wollastonite, inorganic whiskers. Still more preferably, filler (F) is selected from the group consisting of mica, kaolin, calcium silicate, magnesium carbonate, inorganic whiskers, glass fiber and wollastonite.

According to a first embodiment, filler (F) is selected from the group consisting of fibrous fillers. Among fibrous fillers, glass fibers are preferred. Non limiting examples of glass fibers include notably chopped strand A-, E-, C-, D-, S- and R-glass fibers. Glass fibers fillers useful in composition (C) may have a round cross-section or a non-circular cross-section.

In a preferred embodiment of the present invention, the filler (F) is selected from the group consisting of wollastonite fillers and glass fiber fillers. Excellent results were obtained when glass fibers were used.

The weight percent of filler (F) in composition (C) is generally of at least 5 wt %, preferably of at least 10 wt %, more preferably of at least 20 wt %, based on the total weight of composition (C). The weight percent of filler (F) is generally of at most 80 wt %, preferably of at most 70 wt % and most preferably of at most 60 wt %, based on the total weight of composition (C).

Good results were obtained when filler (F) is present in an amount of 10 to 50 wt %, based on the total weight of composition (C), preferably of 20 to 40 wt %, based on the total weight of composition (C).

Composition (C) further comprises at least one impact modifier [impact modifier (IM)]. Suitable impact modifiers (IM) may be selected from the group consisting of ethylene/1-octene copolymers, propylene/1-octene copolymers, ethylene/propylene/1-octene terpolymers, ethylene/1-butene/1-octene terpolymers, propylene/1-butene/1-octene terpolymers, ethylene/1-octene/acrylonitrile terpolymers, ethylene/1-octene/methylacrylate terpolymers, ethylene/1-octene/vinyl acetate terpolymers, ethylene/1-octene/methyl methacrylate terpolymers, propylene/1-octene/acrylonitrile terpolymers, propylene/1-octene/methylacrylate terpolymers, propylene/1-octene/vinyl acetate terpolymers, propylene/1-octene/methyl methacrylate terpolymers, ethylene/1-octene/1,4-hexadiene terpolymers, propylene/1-octene/1,4-hexadiene terpolymers, ethylene/1-octene/ethylidenenorbornene terpolymers, propylene/1-octene/ethylidenenorbonene terpolymers, ethylene-propylene copolymers, ethylene/1-butene and ethylene/1-hexene copolymers, ethylene/propylene/1-butene terpolymers, ethylene/propylene/1-hexene terpolymers, ethylene/propylene/1,4-hexadiene terpolymers, ethylene/propylene/ethylidene norbornene terpolymers (EPDM), butadiene rubbers (cis-1,4-polybutadiene), butyl rubbers (IIR, isobutylene-isoprene rubber), nitrile butadiene rubbers (NBR, copolymers of butadiene with acrylonitrile), styrene-butadiene rubbers (SBR), styrene-butadiene-styrene rubbers (SBS), styrene-ethylene-butadiene-styrene rubbers (SEBS), ethylene-acrylic cross-linked rubbers (copolymers of ethylene with methyl methacrylate), natural rubber, (cis-1,4-polyisoprene).

Impact modifier (IM) may be functionalized for instance by grafting of the unfunctionalized polymer with one or more ethylenically unsaturated monomers bearing at least one functional group. Suitable grafting agents are for instance: acrylonitrile, methacrylonitrile, methylvinyl ketone, unsaturated dicarboxylic acids, esters thereof, and anhydrides thereof, e.g. maleic anhydride; acrylic and/or methacrylic acid, and esters thereof; vinyl acetate.

Impact modifier (IM) is preferably selected from the group consisting of styrene-butadiene rubbers (SBR), styrene-butadiene-styrene rubbers (SBS), styrene-ethylene-butadiene-styrene rubbers (SEBS), maleic anhydride grafted SBS and SEBS, ethylene/1-butene, ethylene/1-hexene and ethylene/1-octene copolymers, ethylene/propylene/ethylidene norbornene terpolymers (EPDM).

Composition (C) contains typically at least 1 wt %, preferably at least 1.5 wt %, more preferably at least 2 wt % of impact modifier (IM) based on the total weight of composition (C). The amount of impact modifier (IM) typically is at most 20 wt %, preferably at most 15 wt %, more preferably at most 10 wt % based on the total weight of composition (C).

Good results were obtained when the impact modifier (IM) is present in an amount of 1 to 20 wt %, based on the total weight of composition (C), preferably of 1.5 to 15 wt %, based on the total weight of composition (C).

Composition (C) may contain other ingredients such as pigments, stabilizers and flame retardants as known in the art. Preferably composition (C) does not contain any metal halide stabilizer.

Composition (C) may be prepared by any conventional method for the preparation of polyamide compositions known in the art, e.g. by melt compounding polyamide (A), filler (F) and impact modifier (IM). Conventional melt compounding devices, such as co-rotating and counter-rotating extruders, single screw extruders, co-kneaders, disc-pack processors and various other types of extrusion equipment can be used. Preferably, extruders, more preferably twin screw extruders can be used. Specially designed extruders, known to the person skilled in the art may be used for melting, blending, extruding and pelletizing composition (C).

A second object of the present invention is a process for the manufacture of a fuel cell component comprising the step of molding composition (C).

The process is generally an injection molding process, wherein composition (C) is injected in a mold at a temperature beyond the melting temperature of the polyamide (A).

Various injection molding techniques may be used. Generally, in all those techniques, the mold will be equipped with multiple injection units. Critical variables such as draft and mold temperature must be considered when using either of these processes. One skilled in the art will recognize the factors influencing injection moldability including the material's stress relaxation properties and the temperature dependence of melt viscosity and exact conditions may be determined by trial and error molding of small samples.

Powders, pellets, beads, flakes, reground material or other forms of the composition (C) may be molded, with or without liquid or other additives, premixed or fed separately.

The design and size of the fuel cell component will depend upon the particular application.

The fuel cell component may comprise multiple parts or elements. The fuel cell component may consist of polymer composition (C) or it may comprise parts or elements made of different materials. Said parts or elements of different materials may be either metallic in nature or made in plastic materials different from composition (C). In cases wherein the fuel cell component is conceived to be equipped with one or more than one parts or elements of different materials, the process may comprise molding the composition (C) in a mold hosting said parts or elements, so that the same are stably and securely embedded in the endplate at the end of the process.

It has been found that the use of polymer composition (C) allows preparing fuel cell components, in particular endplates, that do not crack upon molding or in use even when the size of the component is large.

In particular, the use of composition (C) allows reaching an advantageous balance between mechanical performance of the endplate, amount of contamination from the endplate in the fuel cell environment and cost.

The invention will be now described in more detail with reference to the following examples, whose purpose is merely illustrative and not intended to limit the scope of the invention.

Should the disclosure of any of the patents, patent applications, and publications that are incorporated herein by reference conflict with the present description to the extent that it might render a term unclear, the present description shall take precedence.

### EXAMPLES

### Materials

PA-1+F-1: AMODEL® PPA HFZ A1133 L BK937 (a copolymer of terephthalic acid and isophthalic acid with hexamethylenediamine containing 33 wt % glass fiber) from Solvay Specialty Polymers US, L.L.C.

PA−1+F−1+IM-1: AMODEL® PPA HFZ A1133 L BK937+3.2 wt % IM−1

PA−2+F−1+IM-1: AMODEL® PPA AS 1933 HS BK324 (a copolymer of terephthalic acid, isophthalic acid and adipic acid with hexamethylenediamine containing 33 wt % glass fiber and 3.2 wt % IM-1) from Solvay Specialty Polymers US, L.L.C.

IM-1: KRATON® FG 1091 GT (a maleic anhydride grafted SEBS polymer) from Kraton Polymers US L.L.C.

PSU+F−1: UDEL® GF-120 (a polysulfone polymer containing 20 wt % glass fiber) from Solvay Specialty Polymers US, L.L.C.

General Procedure for the Determination of Contamination of Fuel Cell Membrane

50 g of pellets of each material were placed into a Pyrex glass beaker. 150 g of demineralized water were added and the temperature brought to boiling under stirring with a magnetic bar. The beaker was covered with a watch-glass and demineralized water added when needed to restore initial volume. Three consecutive cycles were carried out as follows: 8 hours stirring at boiling water temperature followed by slow cooling during the night.

A proton exchange membrane of Aquivion® PFSA membrane (available from Solvay Specialty Polymers Italy Spa) was immersed in the solution thus obtained for 1 hour at room temperature. After immersion the membrane was left to dry in open air. The membrane thus obtained was assembled with Solvicore® electrodes H400 in a single cell (Fuel Cell Technology®) having an active area of 25 cm² and tested on an Arbin® 50W test stand.

After 24 hours conditioning at a fixed voltage of 0.6 V a polarization curve was measured to verify the membrane performance. Current density was measured during the 24 hours conditioning to detect changes in the performance of the membrane. In particular an increase in the flow of current in the cell is associated to the release from the membrane of reversibly bound pollutants absorbed by the membrane in the solution. Polarization curves were obtained under the following experimental conditions: Reactants stoichiometry: 2.8 air−3.4 H₂ (pure H₂ 5.5 grade); reactant humidity level: 100%; cell temperature: 75° C.; operating pressure: 2.5 bar (abs).

The results are reported in Table 1.

TABLE 1

| | Composition | Cell conditioning | Polarization |
|---|---|---|---|
| Example 1 | PA-1 + F-1 + IM-1 | ++ | + |
| Comp. Ex. 1 | PA-1 + F-1 | + | −− |
| Comp. Ex. 2 | PA-2 + F-1 + IM-1 | − | − |
| Comp. Ex. 3 | PSU + F-1 | ++ | ++ |

In Table 1: (−−) indicates very poor performance compared to a standard Aquivion ® PFSA membrane; (−) poor performance; (+) acceptable performance; and (++) same performance as the standard.

Selected mechanical properties for the composition of Example 1 and of those of Comparative Examples 1 to 3 are reported in Table 2. Tensile properties (Elongation at break) were measured according to ASTM D638; flexural modulus according to ASTM D790 and Izod notched impact resistance according to ASTM D256.

TABLE 2

| | | | Impact | Flex |
|---|---|---|---|---|
| | | Elonga- | Notched | Modulus |
| | Composition | tion (%) | Izod (J/m) | (MPa) |
| Example 1 | PA-1 + F-1 + IM-1 | 2.4 | 74 | 11300 |
| Comp. Ex. 1 | PA-1 + F-1 | 1.7 | 50 | 11800 |
| Comp. Ex. 2 | PA-2 + F-1 + IM-1 | 2.6 | — | 10600 |
| Comp. Ex. 3 | PSU + F-1 | 3.0 | 53 | 5520 |

Thus the composition according to the invention (Example 1) provides the better balance between flexural modulus and impact resistance on one side and reduced amount of contamination of the fuel cell environment as highlighted by the results in Table 1.

1. A fuel cell component comprising a polymer composition (C) comprising: at least one polyamide (A) comprising recurring units derived from the polycondensation of at least one phthalic acid and hexamethylenediamine and less than 10% moles of recurring units derived from the polycondensation of adipic acid and hexamethylenediamine, at least one reinforcing filler (F), and at least one impact modifier (IM).

2. The fuel cell component according to claim 1, wherein the polyamide (A) is selected from the group consisting of the copolymers of terephthalic acid and isophthalic acid with hexamethylenediamine.

3. The fuel cell component according to claim 1 comprising at least 40 wt % to at most 85 wt % of the polyamide (A), based on a total weight of the composition (C).

4. The fuel cell component according to claim 1, wherein the filler (F) is selected from the group of glass fiber fillers.

5. The fuel cell component according to claim 1 comprising at least 10 wt % to at most 50 wt % of the filler (F), based on a total weight of the composition (C).

6. The fuel cell component according to claim 1, wherein the impact modifier (IM) is selected from the group consisting of styrene-butadiene rubbers (SBR), styrene-butadiene-styrene rubbers (SBS), styrene-ethylene-butadiene-styrene rubbers (SEBS), maleic anhydride grafted styrene-butadiene-styrene rubbers (SBS) and styrene-ethylene-butadiene-styrene rubbers (SEBS), ethylene/1-butene, ethylene/1-hexene and ethylene/1-octene copolymers, ethylene/propylene/ethylidene norbornene terpolymers (EPDM).

7. The fuel cell component according to claim 1 comprising at least 1 wt % to at most 20 wt % of the impact modifier (IM), based on a total weight of the composition (C).

8. A fuel cell component according to claim 1, which consists of composition (C).

9. A fuel cell component according to claim 1, wherein the component is an endplate.

10. A process for manufacturing the fuel cell component according to claim 1, comprising the step of molding composition (C).

11. The process of claim 10, wherein the molding is injection molding.

12. A fuel cell comprising the fuel cell component according to claim 1.
